(19) United States
(12) Patent Application Publication
(10) Pub. No.: US 2010/0293708 A1
(43) Pub. Date: Nov. 25, 2010

(54) METHOD FOR PRODUCING A JOINTLESS SHOWER TRAY AND JOINTLESS SHOWER TRAY

(76) Inventor: Georg Hildebrandt, Derenburg (DE)

Correspondence Address: JORDAN AND HAMBURG LLP, 122 EAST 42ND STREET, SUITE 4000, NEW YORK, NY, 10168, US

(21) Appl. No.: 12/734,751

(22) PCT Filed: Nov. 21, 2008
(86) PCT No.: PCT/DE2008/001923

§ 371 Date: Aug. 11, 2010

(30) Foreign Application Priority Data
Nov. 22, 2007 (DE) 10 2007 056 472.6

(51) Int. Cl. A47K 3/40; B23Q 11/00

(52) U.S. Cl. 4/613; 409/131

(57) ABSTRACT

Disclosed is a method for producing a jointless shower tray, which is installed in baths, or as a separate shower stall, with or without supporting bodies, which is advantageously level with the adjoining floor, and to a jointless shower tray. The drainage surface that collects water and guides it to the drainage opening of the shower tray is created from a material block having at least one plane-parallel surface by way of a material removal machining method. The drainage surface is produced in one operation using a program-controlled three-dimensional machining method, wherein the edge region of the shower tray transitions continuously into the drainage surface at least in the entrance and exit region thereof. This very convenient machining method can be used to configure the surface of the shower bottom, in one uninterrupted operation, in various shapes and without any shoulder whatsoever. In this way, custom-produced shower trays can be produced relatively inexpensively, in any shape desired by the customer, and without edges that would be detrimental to slip-free conditions.

### STATE OF THE ART

The invention relates to a method for producing a jointless shower tray that is installed into baths, or as a separate shower stall with or without supporting bodies. Integrally formed shower trays not only ensure that the shower stall does not leak, they also lend baths an exclusive appearance, in particular if they are made of the same material as the adjoining floor and installed at the same level therewith. In addition, a stepless transition from the bathroom floor to the shower region meets the requirements of a barrier-free bath. The shower tray may comprise any machinable water-proof natural material, such as natural stone or wood, as well as ceramics or synthetic resin-bonded materials. For this purpose, a shower basin is known which comprises a bottom having a peripheral edge and which is made of natural stone, the bottom surface of which has a surface that is stepped from the edge to the water drain. The stepped surface is produced by milling a natural stone block having two plane-parallel surfaces, wherein, for each step, the miller is guided in a plane running parallel to the plane-parallel surfaces (DE 195 41 692 A1). The disadvantage of this shower basin is that the stepped bottom area is not desirable for the feet, even if the difference in height from one step to another is less than 1 mm. In addition, from a purely visual point of view, the surface does not appear homogeneous, which detracts from the aesthetics of the shower stall. Another disadvantage is that water and dirt residues adhere to the steps, and a stepped bottom surface is more difficult to clean than a smooth surface. The complex machining method, during which the miller must be guided at different heights, in keeping with the number of the steps, is also disadvantageous.

Another shower basin made of natural stone comprises a planar bottom having a peripheral edge and a water drain, wherein the bottom has an inclined surface from the edge to the water drain. The edge of the shower basin is connected flush to the adjoining floor covering (DE 201 17 836 U1). The peripheral edge, which is obviously intended to prevent water from escaping into the region of the floor covering, is undesirable in two respects: firstly, it impairs the overall aesthetic effect of the shower basin made from natural stone, because it constitutes a clear visual interruption between the shower basin and the adjoining floor covering, and secondly the edge formed by it is undesirable for the human foot and/or at times poses a fairly significant risk of injury. In addition, joining the shower basin and floor covering involves additional cost.

### THE INVENTION AND BENEFITS THEREOF

The method according to the invention having the characteristics of claim 1 is a very convenient machining method, with which a shower bottom surface design can be achieved in various shapes, in one uninterrupted operation. The desired shape for the shower bottom that forms the water drainage surface is stored in a data processing program, which controls a CNC machining center, for example. In this way, material blocks made of noble, and consequently expensive, natural materials, such as marble, granite, hard woods and the like, can be used to produce shower trays for exclusive baths in any shape desired by the customer, relatively inexpensively, with each shower tray being a substantially custom-made item. The shape of the shower bottom relates not only to the pure gradient surface, but also to the peripheral shape, which is to say, the edge region at which the gradient begins, and the opening for water drainage. Arbitrary shapes are likewise conceivable in the configuration of the edge. Configurations for flow toward the drain can notably be integrated in the machining method when creating the drainage surface, such as by way of producing arbitrarily arched surfaces, which differ from customary flow configurations that drop off in the inward direction in a flat manner.

Producing a shower tray from a material that can be configured by way of material removal machining methods is also advantageous in that the transition from the outer edges of the material block to the visible surface can be designed with sharp edges, this being a quasi linear configuration. This necessary in order to connect the floor adjacent the shower tray to the shower tray with the smallest possible joint width. In addition, the use of the term “shower tray” instead of “shower basin” is intended to clarify that this invention is not a basin-shaped collection container for the shower water, but a tray that is harmoniously integrated in the floor of a bathroom, which additionally ensures the function of water drainage.

According to an advantageous embodiment of the invention, the drainage surface of the shower tray is produced first, wherein the machining tool is moved away from the upper edge to the lowest point of the shower tray and in the reverse direction. Whenever the machining tool moves toward the edge of the shower tray, it ends at the surface of the shower tray, thereby creating a stepless transition from the drainage surface to the edge of the shower tray. When proceeding in this way, the contour of the drainage surface is formed successively over the course of the machining operation. It is therefore also possible to visually highlight the drainage surface with respect to the edge region of the shower tray without an undesirable shoulder. The shoulder-free transition from the drainage surface to the unmachined edge region is particularly important for the entrance and exit region of the shower tray. The advantage of the shoulder-free transition also exists for shower trays that have no horizontal edge region or only a partial horizontal edge region, which is to say that the upper edge of the drainage surface also constitutes the outer edge of the shower tray, in at least some regions. In such a shower tray, the upper edge of the drainage surface, or parts thereof, likewise connect directly to the floor without a shoulder.

According to another advantageous embodiment of the invention, the contour of the upper edge of the drainage surface is initially produced after producing the material block. In general, the material blocks will have two plane-parallel surfaces. In this case, the edge contour will be a closed horizontal having an arbitrary shape, from which the gradient, which also has an arbitrary configuration, will lead toward the drainage opening of the shower tray. Starting the machining operation with this horizontal simplifies the programming for the machining process.

According to a further advantageous embodiment of the invention, the upper edge adjoining the unmachined edge of the shower tray is chamfered onto the draining surface. In this way, the transition from the drainage surface to the edge of the shower tray is even more smooth. This is particularly advantageous when minor differences in height occur due to the thickness tolerances of the material block in this transition region, with these differences ranging from several tenths of a millimeter to several millimeters. These differences in height are concealed by chamfering.

According to a further advantageous embodiment of the invention, the production of the drainage opening is integrated into the machining method. In the production of a covered drain, the creation of the recess for the cover of the drainage opening is integrated into the method at the same time. As a result, the shower tray is produced in an uninterrupted process. This procedure is also advantageous because, in the program control, the position of the drainage opening must always be considered as the lowest point of the drainage surface.

According to an advantageous embodiment of the invention in this respect, the drainage opening is incorporated in the shower tray at the lowest point thereof after completion of the drainage surface, without interrupting the machining operation. In the production of a covered drain outlet, the creation of the recess for covering the drain outlet is integrated into the method at the same time. In this way, the machining tool only has to work the material block at the thinnest area thereof. Of course, it is also conceivable to first include the opening for the drain outlet in the material block, and subsequently create the drainage surface between this opening and the edge.

According to an advantageous embodiment of the invention, the drainage surface and the drainage opening are created from the material block by way of 3D milling. This method enables fast machining using conventional tools and machining centers and is therefore particularly inexpensive.

According to a different advantageous embodiment of the invention, the drainage surface of the shower tray undergoes a finishing operation. For example, by way of a final sand blasting step wherein, depending on the grain size that is used, the surface can be refined or roughened in order to achieve improved the slip-free conditions. It is also possible to incorporate patterns and thus improve the aesthetic appearance in this manner.

A shower tray produced according to the invention is characterized in that the transition from the unmachined edge surface of the base body to the machined drainage surface is configured continuously, which is to say, without undesirable shoulders, at least in the exit region. In this way, this region will substantially not be felt by the human foot and therefore does not pose a risk of injury.

According to an advantageous embodiment of the invention in this respect, the transition from the edge region into the drainage surface is configured as a continuously machined surface surrounding the drainage surface as a closed contour. In this way, the peripheral shape of the drainage surface, as it is provided for according to the programming, is particularly well highlighted, because the surface structure of this edge region is continuously varied by the machining tools, regardless of the thickness tolerances of the material block. Because the thickness tolerances are generally only a few tenths of a millimeter to one millimeter, no perceivable shoulder will be created. This continuously machined edge region can be produced at the beginning of the machining process, as is described in claim 3. However, in addition to the aesthetic effect, this edge region has another essential technical function: because it has a rougher surface structure than the adjoining unmachined edge, it also interrupts the capillary effect of the water, thereby preventing water from flowing to the exterior.

Further advantages and advantageous embodiments of the invention will be apparent from the following description, the drawings, and the claims.

### DRAWINGS

One embodiment of the invention is illustrated in the drawings and described in more detail hereafter. In the drawings:

FIG. 1 is a schematic perspective view of a shower tray produced according to the invention, and of shower partitions;

FIG. 2 is the shower tray of FIG. 1 alone in a perspective view;

FIG. 3 is a sectional view of the shower tray of FIG. 2;

FIG. 4 is the shower tray of FIG. 2 in the installed state;

FIG. 5 shows a shower stall comprising a shower tray having a peripheral water drain;

FIG. 6 is a sectional view of the shower tray of FIG. 5;

FIG. 7 is a top view of the shower tray of FIG. 5;

FIG. 8 is a shower tray having an additional overflow groove;

FIG. 9 shows examples of possible shapes of the drainage surfaces of shower trays;

FIG. 10 is a double shower tray;

FIG. 11 is a shower tray having a round outer shape;

FIG. 12 is a shower tray having an elongated drain opening;

FIG. 13 is a shower tray having a drainage surface delimited in an arc shape; and

FIG. 14 is the shower tray of FIG. 13 having a curved drain opening.

### DESCRIPTION OF THE EMBODIMENTS

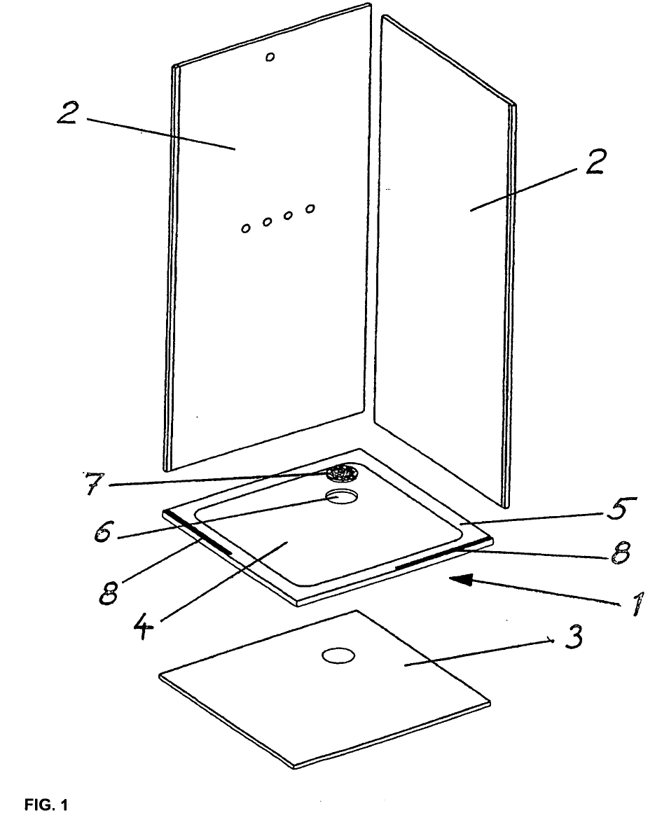

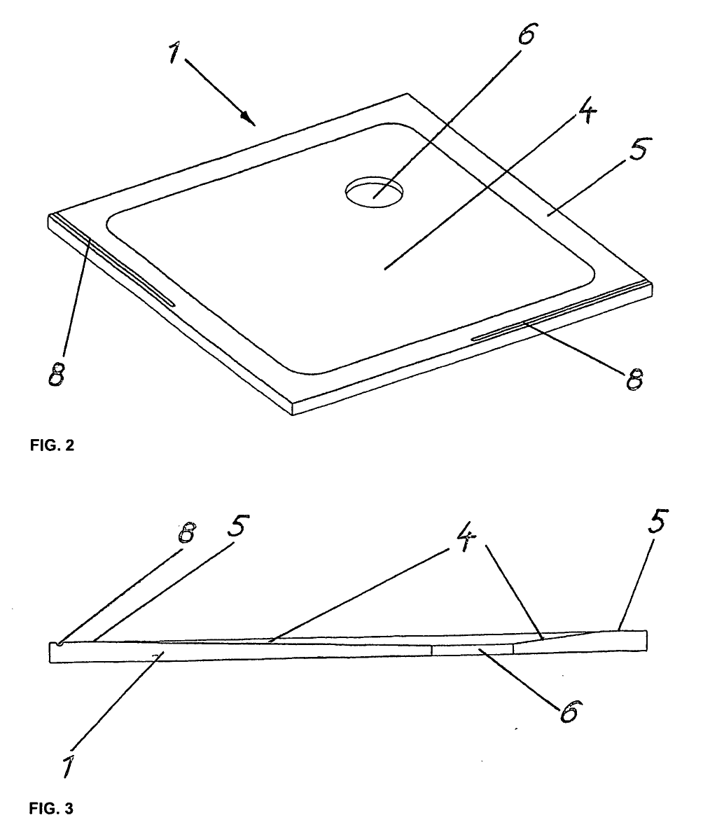

FIG. 1 shows the main components of a shower stall comprising a shower tray 1 according to the invention, two wall panels 2, and a base panel 3. The shower tray 1 according to the invention has a square configuration in this variant, and is shown in more detail in FIGS. 2 and 3. The surface thereof is formed by an uninterrupted, slightly concave gradient surface 4 and an outer edge 5 surrounding the same. Although it is produced by a material removal method, the gradient surface 4 has no edges or shoulders whatsoever, including such as could be caused by the production thereof, so that from the outer edge to the water drain the quality, in terms of haptic perception, is clearly comparable to that of the smooth surfaces of deep-drawn or cast shower basins. As is apparent from FIG. 3, the outer edge 5 also transitions into the gradient surface 4 without a shoulder or edge. At the lowest point, the gradient surface 4 has an opening 6 for connecting to the drainage system of the shower stall, and the opening can be closed by a cover 7. The wall panels 2 are placed on the outer edge 5 of the shower tray 1 and sealed, with respect to the same, and at the longitudinal edges of the panels abutting each other. Grooves may be incorporated in the shower tray 1 in order to receive the wall panels 2. In the present example, however, grooves 8 for receiving shower partitions closing off the shower stall are only incorporated in the outer edge 5.

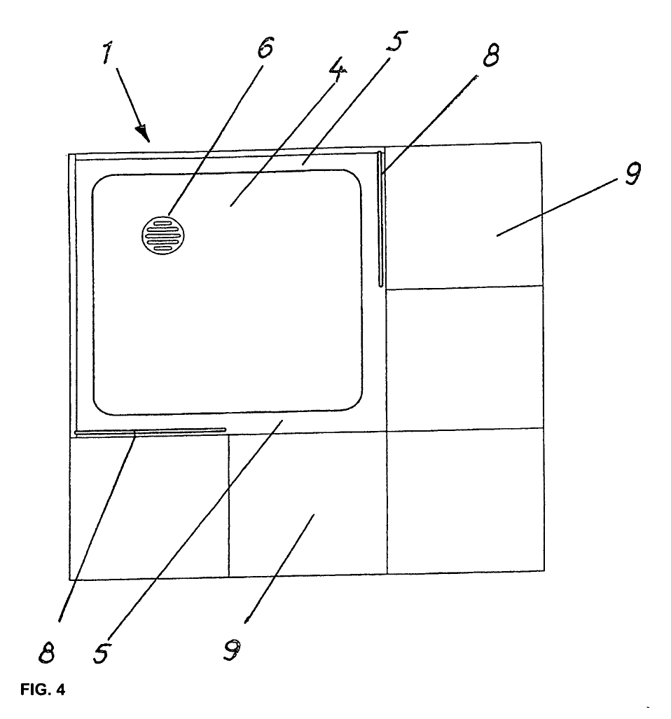

The arrangement of the shower tray 1, with respect to an adjoining floor 9, is illustrated in FIG. 4. In order to install the shower stall, a depression corresponding to the dimensions of the shower tray 1 is provided in the floor 9, and the depth of the depression, as measured from the upper edge of the floor 9 to the support surface of the base panel 3, corresponds to the thickness of the shower tray 1 and base panel 3, so that the surface of the floor 9 and the outer edge 5 of the shower tray 1 form one level.

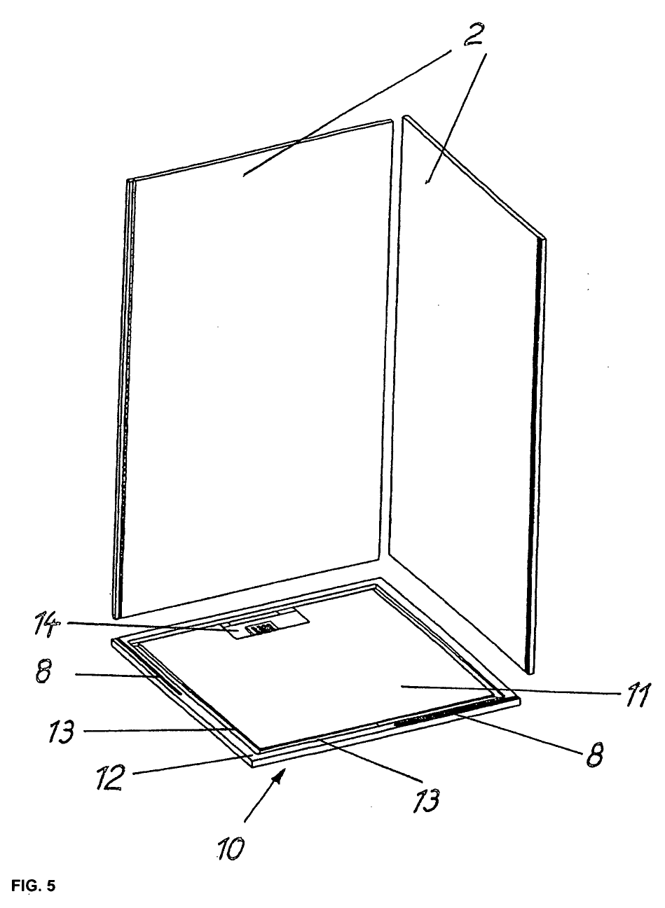

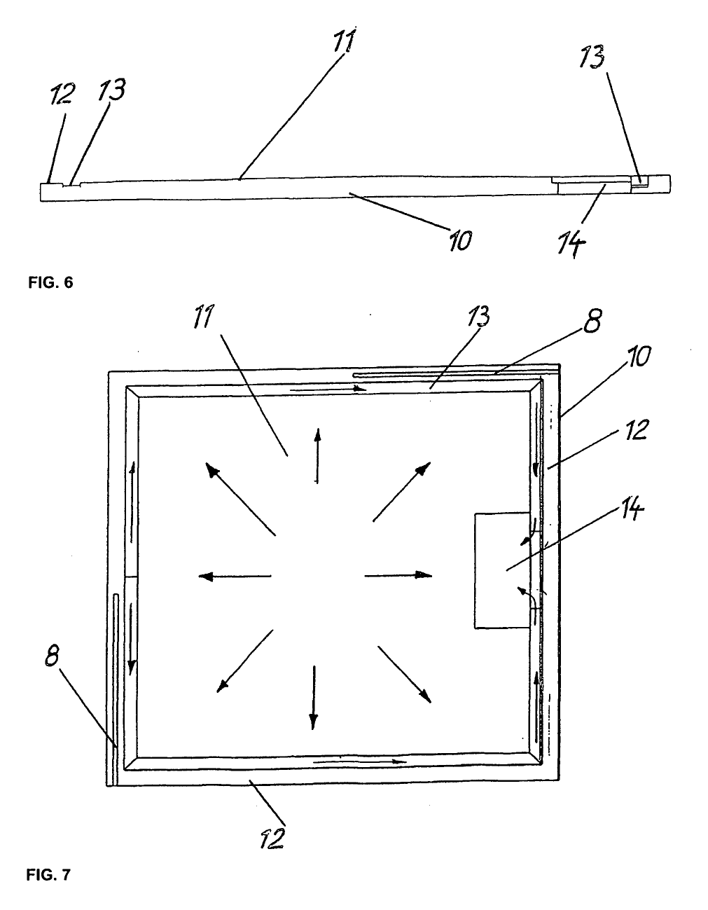

A second embodiment illustrated in FIGS. 5 to 7 describes a shower stall having a shower tray 10, the drainage surface 11 of which has a slightly convexly arched shape, which is to say the highest point is located at the center thereof. The gradient of the drainage surface 11 leads to a drain groove 13 which extends peripherally at the outer edge 12 of the shower tray 10 and which in turn has a gradient toward a drainage opening 14, advantageously disposed at the edge of the shower tray 10. The gradient is indicated in each case by arrows. In the top view of the shower tray 10 shown in FIG. 7, the two grooves 8 for receiving shower partitions are also apparent.

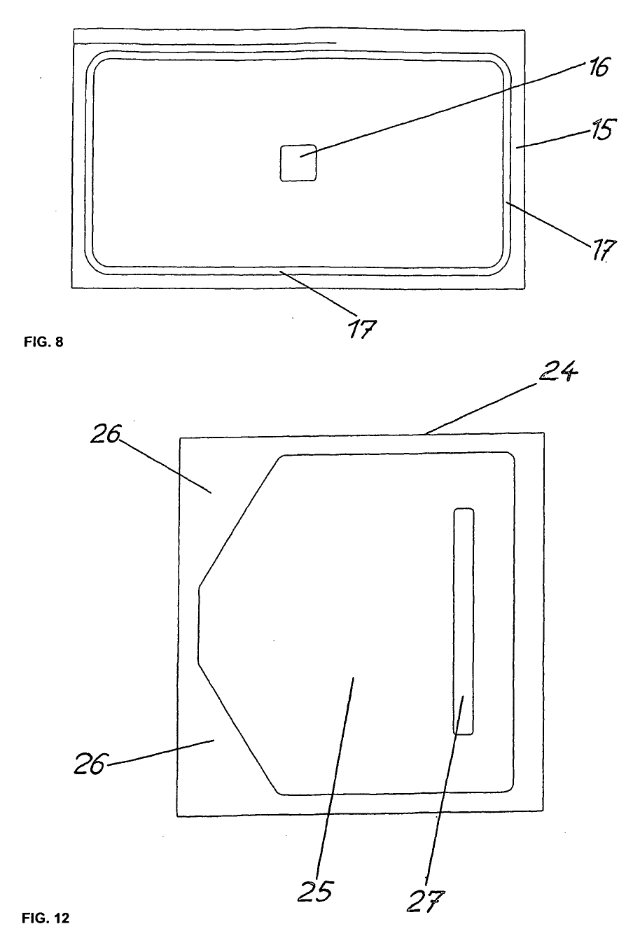

FIG. 8 shows a shower tray 15 having a rectangular shape, in which a peripheral overflow groove 17 is incorporated in the outer edge, in addition to a drainage opening 16. The groove can be up to one millimeter deep and is used to interrupt the water flow to the outer edge.

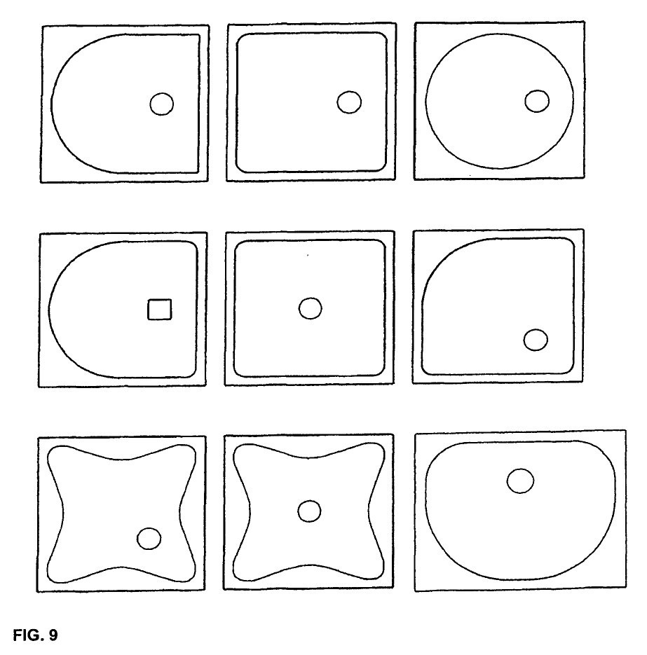

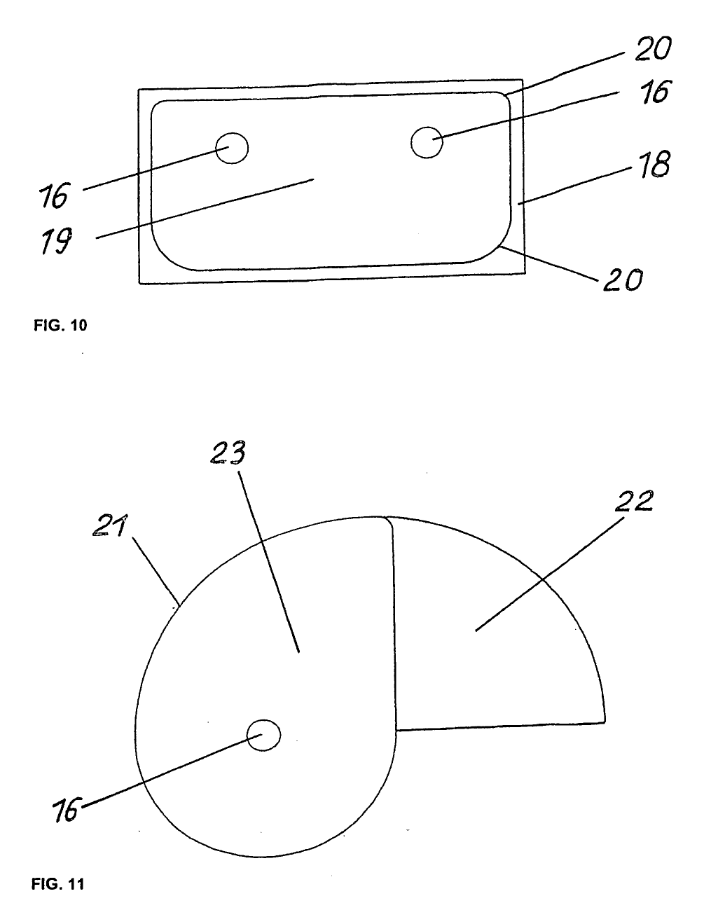

FIGS. 9 to 14 are provided to illustrate the diverse design possibilities of shower trays achieved by the machining method according to the invention. FIG. 9 shows nine shower trays having rectangular outer shapes and drainage toward the inside, wherein the drainage surfaces have arbitrary and different outer delimitations and the openings for drainage are disposed at arbitrary positions in the shower tray. The resulting differently concavely shaped drainage surfaces can be produced without great cost when using the machining method according to the invention, without producing noticeable edges. Even the outer delimitation of the drainage surface, which in all figures is shown by a closed line to illustrate the shape, is not perceptible when entering the shower tray, but only apparent due to the different surface structures of the horizontal outer edge and the drainage surface resulting from different machining operations. FIG. 10 shows a double shower tray 18 which can be used by two people at the same time and has two drainage openings 16, wherein the drainage surface 19 is given different radii 20 at the front and back.

A shower tray 21 configured, at the exterior, in a snail profile is shown in FIG. 11. It comprises a flat part 22, which has the shape of a quadrant, and a gradient part 23, in which the drainage opening 16 is located. The flat part 22 can be designed as the entrance region for the shower. The gradient starts directly on the outer round edge of the shower tray 21, without a flat edge region. Installing such a shower tray, however, is associated with greater effort in terms of the design of the adjoining floor, which must be adapted to the snail shape of the shower tray 21. Of course, it is also possible to produce such a shower tray as a block shaped tray and create the snail shape of the gradient 23 in the tray by way of the method according to the invention, so that the upper edge of the gradient part 23 transitions in a stepless manner into a flat, optionally unmachined edge surface.

FIG. 12 in turn shows a shower tray 24 having a rectangular outer shape. The drainage surface 25 thereof substantially follows the outer shape. A wider flat edge region 26 is only provided in the entrance region to the shower, on the right and left. An elongated drainage opening 27 is disposed in the drainage surface 25. Such a shower tray 24 can also be used by two people at the same time.

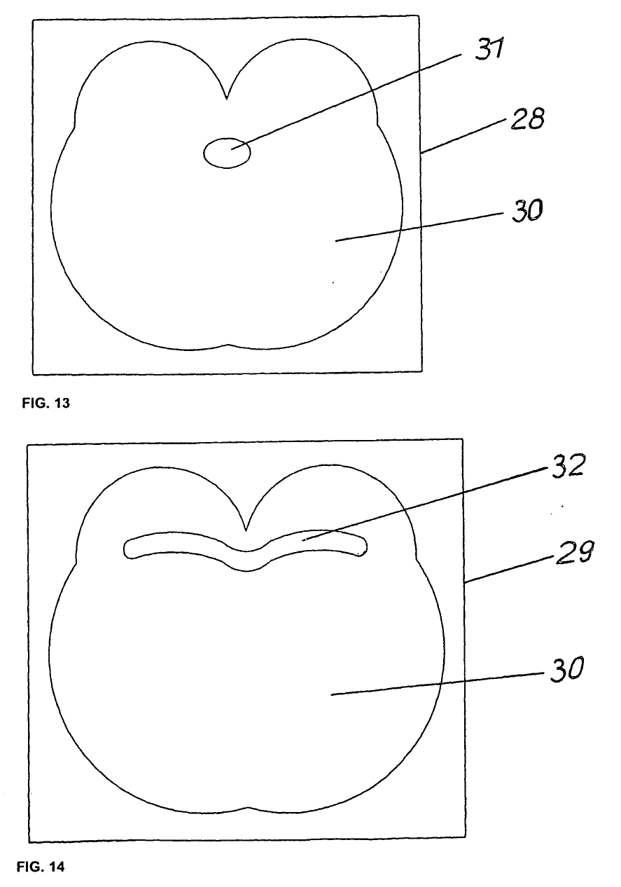

FIGS. 13 and 14 show two shower trays 28 and 29 having drainage surfaces 30 that are delimited by circular arcs, wherein the shower tray 28 has an elliptical drainage opening 31 and the shower tray 29 has an elongated curved drainage opening 32.

All characteristics provided in the description, the following claims, and the drawing can be essential for the invention, both individually, or in any arbitrary combination with each other.

### LIST OF REFERENCE NUMERALS

1 Shower tray
2 Wall panel
3 Base panel
4 Gradient surface
5 Outer edge
6 Opening
7 Cover
8 Grooves
9 Floor
10 Arched shower tray
11 Drainage surface
12 Outer edge
13 Drain groove
14 Drainage opening
15 Rectangular shower tray
16 Drainage opening
17 Overflow groove
18 Double shower tray
19 Drainage surface
20 Radii
21 Shower tray
22 Flat part
23 Gradient part
24 Shower tray
25 Drainage surface
26 Edge region
27 Elongated drainage opening
28 Shower tray
29 Shower tray
30 Drainage surface
31 Elliptic drainage opening
32 Curved drainage opening

1. A method for producing a jointless shower tray comprising providing a material block of machinable waterproof material having at least one plane-parallel surface, using material removal machining methods, to produce a drainage surface for collecting the water and guiding the water to a drainage opening, of the shower tray, and producing the drainage surface in one operation using a program-controlled three-dimensional machining method.

2. The method according to claim 1, comprising initially producing the drainage surface with a machining tool being moved away from an upper edge to the lowest point of the shower tray and in the reverse direction, thereby producing a step-free transition from the drainage surface to an edge surrounding the drainage surface.

3. The method according to claim 1, comprising first producing a contour at the upper edge of the drainage surface.

4. The method according to claim 3, comprising producing a chamfer at the upper edge adjoining an unmachined edge of the shower tray, the chamfer extending onto the draining surface.

5. The method according to claim 1, comprising integrating the production of the drainage opening into the machining process.

6. The method according to claim 5, incorporating the drainage opening at the lowest point of the drainage surface after completion of the same.

7. A method according to claim 1, wherein the machining of the shower tray is carried out by 3D milling.

8. A method according to claim 1, comprising effecting a finishing operation of the drainage surface of the shower tray.

9. A jointless shower tray, comprising a material block having at least one plane-parallel surface, a drainage surface thereof collecting the water and guiding the water to a drainage opening of the shower tray, the shower tray being surrounded by an edge region, the edge region continuously transitions into the drainage surface at least in the region of the entrance and exit of the shower tray.

10. The jointless shower tray according to claim 9, wherein the transition from the edge region into the drainage surface is configured as a continuously machined surface surrounding the drainage surface as a closed contour.

11. The jointless shower tray according to claim 9, wherein the shower tray is produced according to the method described in claim 1.
